(19) United States
(12) Patent Application Publication
(10) Pub. No.: US 2026/0043467 A1
(43) Pub. Date: Feb. 12, 2026

(54) SUPERCRITICAL CARBON DIOXIDE ZERO LEAKAGE DRY GAS SEALING DEVICE AND METHOD

(71) Applicant: Nuclear Power Institute of China, Chengdu (CN)

(72) Inventors: Yaoxing CHEN, Chengdu (CN); Yanping HUANG, Chengdu (CN); Le MA, Chengdu (CN); Xiuting LIU, Chengdu (CN); Wenbin ZHUO, Chengdu (CN); Lv YE, Chengdu (CN); Yu JIANG, Chengdu (CN)

(73) Assignee: Nuclear Power Institute of China, Chengdu (CN)

(21) Appl. No.: 19/362,278

(22) Filed: Oct. 17, 2025

Related U.S. Application Data
(63) Continuation of application No. PCT/CN2024/124142, filed on Oct. 11, 2024.

(30) Foreign Application Priority Data
Feb. 5, 2024 (CN) 202410162411.4

(51) Int. Cl. F16H 57/029; F17D 1/02; F17D 3/01

(52) U.S. Cl. CPC F16H 57/029; F17D 1/02; F17D 3/01

(57) ABSTRACT

A supercritical carbon dioxide zero leakage dry gas sealing device includes a main gas flow path, a main gas flow branch, an isolation gas flow branch, a pressure reducing valve, and a temperature control assembly. One end of the main gas flow branch is in communication with the main gas flow path and the sealing cylinder. The isolation gas flow branch is in communication with the main gas flow path and the gearbox. The pressure reducing valve is arranged on the isolation gas flow branch. The temperature control assembly is configured to control the temperature of the injection gas flow based on the gas flow pressure of the injection gas flow introduced into the main gas flow path.

### CROSS-REFERENCE TO RELATED APPLICATIONS

The present application is a continuation application of International Application No. PCT/CN2024/124142, filed on Oct. 11, 2024, which claims priority to Chinese Patent Application No. 202410162411.4, filed with the China National Intellectual Property Administration on Feb. 5, 2024. All of the aforementioned applications are incorporated herein by reference in their entireties.

### TECHNICAL FIELD

The present application relates to the technical field of sealing devices, and in particular to a supercritical carbon dioxide zero leakage dry gas sealing device and method.

### BACKGROUND

Dry gas sealing serves as a shaft sealing device for a supercritical carbon dioxide compressor or turbine and is crucial for ensuring efficient operation of the compressor or turbine. The dry gas sealing includes a sealing cylinder, a moving ring, a stationary ring, as well as a set of an auxiliary spring, a spring seat, and a shaft sleeve. In order to ensure the safe operation of dry gas sealing, dry gas sealing isolation gas needs to be introduced to effectively isolate the oil from gas in the downstream gearbox.

At present, the isolation gas usually adopts a carbon dioxide working fluid. In order to make the compressor or turbine compact in structure, and avoid the use of additional auxiliary pressurizing devices (including a booster pump, a storage tank, a heater, etc.), the isolation gas is usually extracted from a main gas system associated with the supercritical carbon dioxide compressor or turbine. However, the pressure of the carbon dioxide working fluid in the main gas system generally ranges from 6 to 20 MPa, while the pressure of the isolation gas at the outlet, after pressure reduction, is often a slight positive pressure. Under such high-pressure difference conditions, the temperature variation of the isolation gas flow at the outlet increases significantly, resulting in a larger temperature difference between the isolation gas flow and the oil temperature at the inlet of the bearing in the gearbox. This in turn affects the oil temperature at the inlet of the bearing in the gearbox, which must remain within a certain temperature range to ensure the efficient operation of the shaft bearing. Therefore, the excessive temperature difference at the outlet of the isolation gas can significantly impact the bearing in the gearbox, thereby affecting the safe operation of the supercritical carbon dioxide compressor or turbine.

### SUMMARY

The main purpose of the present application is to provide a supercritical carbon dioxide zero leakage dry gas sealing device and method, which aim to solve the technical problem that the high temperature of the existing isolation gas flow affects the oil supply temperature of the bearing in the gearbox.

In order to achieve the above purpose, the present application provides a supercritical carbon dioxide zero leakage dry gas sealing device, including a sealing cylinder and a moving ring and a stationary ring arranged inside the sealing cylinder. The dry gas sealing device further includes: a main gas flow path configured to introduce an injection gas flow into the sealing cylinder and a gearbox; a main gas flow branch, one end of the main gas flow branch being in communication with the main gas flow path, and the other end of the main gas flow branch being in communication with the sealing cylinder; an isolation gas flow branch, one end of the isolation gas flow branch being in communication with the main gas flow path, the other end of the isolation gas flow branch being in communication with the gearbox, and the isolation gas flow branch being arranged in parallel to the main gas flow branch; a pressure reducing valve disposed on the isolation gas flow branch; and a temperature control assembly, configured to control the temperature of the injection gas flow based on the gas flow pressure of the injection gas flow introduced into the main gas flow path, so that the temperature of the leakage gas flow from the dry gas sealing device and the temperature of the gas flow at the outlet of the isolation gas flow branch are adapted to the oil temperature at the inlet of the bearing in the gearbox.

In an embodiment, the sealing cylinder is provided with an injection hole, the injection hole is located on a side of the movable ring facing away from the gearbox, and the injection hole is in communication with the main gas flow branch.

In an embodiment, the dry gas sealing device further includes a pressure reducing structure for sharing a pressure drop load borne by the pressure reducing valve.

In an embodiment, the pressure reducing structure includes a resistance member and a throttling hole, the resistance member is disposed on a side of the pressure reducing valve adjacent to the main gas flow path, and the throttling hole is disposed on a side of the pressure reducing valve away from the main gas flow path.

In an embodiment, a side of the gearbox adjacent to the sealing cylinder defines a pressure regulating groove, and the pressure regulating groove is in communication with the isolation gas flow branch.

In an embodiment, the resistance member has a plurality of first protrusion portions, and the plurality of first protrusion portions are connected in series.

In an embodiment the pressure regulating groove is provided with a plurality of second protruding portions, the plurality of second protruding portions are connected in series, and the plurality of second protruding portions are arranged in a symmetrical or staggered form.

In order to achieve the above purpose, the present application further provides a supercritical carbon dioxide zero leakage dry gas sealing method, in which the temperature of the injection gas flow is controlled by the supercritical carbon dioxide zero leakage dry gas sealing device as described above.

In an embodiment, the gas flow pressure of the injection gas flow introduced in the main gas flow path ranges from 6 MPa to 20 MPa.

In an embodiment, a relationship between the gas flow pressure and the temperature of the injection gas flow introduced in the main gas flow path is expressed as follows:

$${T}_{min} = - 0.0032 {P}^{3} + 0.0041 {P}^{2} + 6.0759 P + 42.2 \; 62 ; and$$

$${T}_{max} = 0.0118 {P}^{3} - 0.5304 {P}^{2} + 11.581 P + 48.1 \; 13 ;$$

Tₘᵢₙ denotes the lowest temperature of the injection gas flow, Tₘₐₓ denotes the highest temperature of the injection gas flow, and P denotes the gas flow pressure of the injection gas flow.

Beneficial effects achieved by the present application are as follows.

The embodiments of the present invention provide a supercritical carbon dioxide zero leakage dry gas sealing device which includes a sealing cylinder as well as a moving ring and a stationary ring arranged in the sealing cylinder. The dry gas sealing device further includes a main gas flow path, a main gas flow branch, an isolation gas flow branch, a pressure reducing valve and a temperature control assembly. During operation, the injection gas flow is introduced into the total gas flow path, and is then divided into two branches. One branch flows into the sealing cylinder through the main gas flow branch, and the other branch flows into the gearbox through the isolation gas flow branch. The pressure of the gas flow in the isolation gas flow branch is reduced by the pressure reducing valve. During operation of the dry gas sealing device, the temperature of the injection gas flow introduced into the main gas flow path is regulated by the temperature control assembly, such that the temperature of the leakage gas flow from the dry gas sealing device, the temperature of the gas flow at the outlet of the isolation gas flow branch are adapted to the oil temperature at the inlet of the bearing in the gearbox. That is, the temperature of the leakage gas flow from the dry gas sealing device and the temperature of the gas flow at the outlet of the isolation gas flow branch do not excessively affect the oil temperature at the inlet of the bearing in the gearbox. This effectively reduces the impact of the injection gas flow on the oil temperature at the inlet of the bearing in the gearbox, thereby ensuring the safe operation of the supercritical carbon dioxide compressor or turbine.

### BRIEF DESCRIPTION OF THE DRAWINGS

FIG. 1 is a schematic structural diagram of a supercritical carbon dioxide zero leakage dry gas sealing device according to an embodiment of this application, in which second protruding portions are arranged in a symmetrical form.

FIG. 2 is an enlarged partial schematic view of the portion A in FIG. 1.

FIG. 3 is a schematic structural diagram of a supercritical carbon dioxide zero leakage dry gas sealing device according to an embodiment of this application, in which second protruding portions are arranged in a staggered manner.

FIG. 4 is an enlarged partial schematic view of the portion B in FIG. 2.

The objectives, functional features, and advantages of the present disclosure will be further described with reference to the accompanying drawings in combination with the embodiments.

### DETAILED DESCRIPTION OF THE EMBODIMENTS

The following clearly and completely describes the technical solutions in the embodiments of this application with reference to the accompanying drawings in the embodiments of this application. It is apparent that the described embodiments are merely part rather than all of the embodiments of the present application. All other embodiments obtained by a person of ordinary skill in the art based on the embodiments of this application without creative efforts shall fall within the protection scope of this application.

It should be noted that all directional indications (such as upper, lower, left, right, front, and back) in the embodiments of this application are merely used to describe the relative positional relationships, movement conditions, and the like between components under a specific posture (e.g., as shown in the drawings). If the specific posture changes, the corresponding directional indications shall be changed accordingly.

In this application, unless otherwise specified and limited, the terms “connected”, “fixed”, and the like should be understood in a broad sense, for example, “fixed” may be a fixed connection, a detachable connection, or an integral formation. It may refer to a mechanical connection or an electrical connection, a direct connection or an indirect connection via an intermediate medium, communication or interaction between components, either internally or externally, unless explicitly defined otherwise. Those skilled in the art will understand the specific meanings of the above terms in the context of this application based on particular situations.

In addition, if the embodiments of the present application refer to descriptions such as “first” and “second,” such expressions are merely for the purpose of description and should not be construed as indicating or implying relative importance or the number of the technical features referred to. Thus, features defined with “first,” “second,” etc., may expressly or implicitly include at least one such feature. Furthermore, the term “and/or” as used throughout the present disclosure is intended to include three scenarios. For example, “A and/or B” covers: A alone, B alone, and both A and B together. In addition, the technical solutions among various embodiments described herein may be combined with each other, provided that such combinations can be implemented by those of ordinary skill in the art. However, when combinations of technical solutions result in contradictions or are not practically feasible, such combinations should be deemed to fall outside the scope of the present application.

It is found through analysis that because there is a narrow flow channel gap between the moving ring and the stationary ring, it is necessary to pay attention to the impurity management and control work of the dry gas seal, so as to avoid the wear of the moving ring and the stationary ring, thereby avoiding the dry gas sealing failure. For example, the oil and gas of the downstream gearbox may backflow to the sealing surfaces of the moving ring and the stationary ring. Therefore, in order to ensure the safe operation of the dry gas seal, dry gas sealing isolation gas needs to be introduced to effectively isolate the oil and gas in the downstream gearbox. In operating scenarios that allow external leakage, the compressed gas working fluid is used as the gas source for the isolation gas. However, in zero-leakage closed-loop scenarios, introducing external gas would reduce the purity of the supercritical carbon dioxide working fluid, resulting in a carbon dioxide purity level that fails to meet usage requirements. Thus, the isolation gas must also use carbon dioxide as the working fluid. In order to make the compressor or turbine compact, no additional boost devices (including booster pumps, storage tanks, heaters, etc.) are introduced, the isolation gas is usually extracted from the main gas system associated with the supercritical carbon dioxide compressor or turbine. However, the pressure of the carbon dioxide working fluid in the main gas system generally ranges from 6 MPa to 20 MPa, while the pressure of the isolation gas at the outlet, after pressure reduction, is typically only slightly positive. Under such a large pressure differential, the temperature variation of the isolation gas flow at the outlet increases significantly. As a result, the temperature difference between the isolation gas flow and the oil temperature at the inlet of the bearing in the gearbox also increases, which affects the oil temperature at the inlet of the bearing in the downstream gearbox which must remain within a certain range to ensure the efficient operation of the bearing. Therefore, when introducing the isolation gas flow, an excessively large temperature difference at the outlet may significantly affect the bearings in the gearbox, which could affect the safe operation of the supercritical carbon dioxide compressor or turbine.

Therefore, it is necessary to control the temperature of the isolation gas flow under the large pressure difference, thereby reducing the influence of the isolation gas on the oil temperature at the inlet of the bearing in the gearbox.

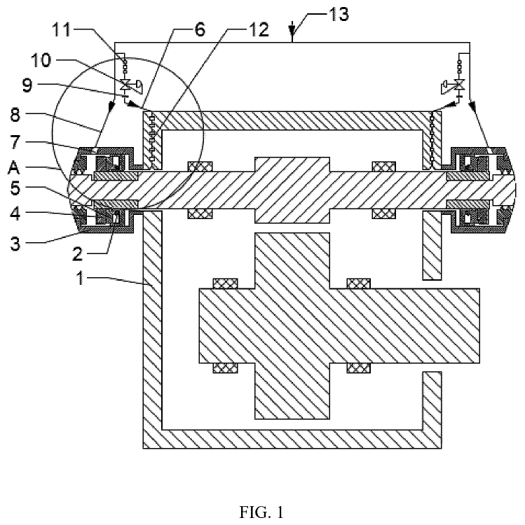

Referring to FIG. 1, an embodiment of the present application provides a supercritical carbon dioxide zero leakage dry gas sealing device, including a sealing cylinder 3, a moving ring 4 and a stationary ring 5 that are disposed inside the sealing cylinder 3, a main gas flow path 13, a main gas flow branch 8, an isolation gas flow branch 6, a pressure reducing valve 10, and a temperature control assembly.

It can be seen from the prior art that the side of the stationary ring 5 away from the moving ring 4 is usually provided with a spring 2 to apply a fitting force to the stationary ring 5, thereby ensuring close contact between the moving ring and stationary ring 5 under a static condition. During operation of the dry gas sealing, the moving ring 4 and the stationary ring 5 cooperate with each other, and the injection gas flow from the main gas flow path 13 can form a rigid gas film between the moving ring 4 and the stationary ring 5. When the static pressure of the fluid and the closing force generated by the load of the spring 2 are equal to the opening force generated in the gas film, a stable gap between the radial faces is formed.

The main gas flow path 13 is configured to introduce an injection gas flow into the sealing cylinder 3 and the gearbox 1, one end of the main gas flow path 13 serves as an input end of the injection gas flow. The injection gas flow is input through a port of the main gas flow path 13, flows through the main gas flow path 13, and then flows into the main gas flow branch 8 and the isolation gas flow branch 6, and finally flows into the sealing cylinder 3 and the gearbox 1, respectively.

The main gas flow branch 8 is configured to introduce an injection gas flow into the sealing cylinder 3, one end of the main gas flow branch 8 is in communication with the main gas flow path 13, and the other end of the main gas flow branch 8 is in communication with the sealing cylinder 3. The injection gas flow flows through the main gas flow branch 8 and then flows into the sealing cylinder 3, thereby forming a rigid gas film between the moving ring 4 and the stationary ring 5.

The isolation gas flow branch 6 is configured to introduce an injection gas flow into the gearbox 1, one end of the isolation gas flow branch 6 is in communication with the main gas flow path 13, the other end of the isolation gas flow branch 6 is in communication with the gearbox 1. The isolation gas flow branch 6 is arranged in parallel to the main gas flow branch 8. The injection gas flow flows through the isolation gas flow branch 6 and then flows into the gearbox 1 to play a role in oil and gas isolation.

The pressure reducing valve 10 is disposed on the isolation gas flow branch 6, and is configured to depressurize the isolation gas pressure in the isolation gas flow branch 6, so that the gas flow at the outlet of the isolation gas flow branch 6 has a micro-positive pressure.

The temperature control assembly is configured to control the temperature of the injection gas flow based on the gas flow pressure of the injection gas flow introduced into the main gas flow path 13, so that the temperature of the leakage gas flow from the dry gas sealing device and the temperature of the gas flow at the outlet of the isolation gas flow branch 6 are adapted to the oil temperature at the inlet of the bearing in the gearbox 1.

It can be understood that the zero leakage dry gas sealing device refers to that the dry gas seal is directly connected to the gearbox 1 in a sealed manner. Therefore, when considering the influence on the oil temperature at the inlet of the bearing in the gearbox 1, the change of the temperature of the leakage gas flow of the dry gas sealing device needs to be considered, and the temperature of the leakage gas flow of the dry gas sealing device is basically consistent with the temperature of the gas flow at the outlet of the isolation gas flow branch 6. Therefore, the temperature of the injection gas flow introduced in the main gas flow path 13 and the temperature of the gas flow at the outlet of the isolation gas flow branch 6 are adapted to the oil temperature at the inlet of the bearing in the gearbox 1 by regulating the temperature of the injection gas flow introduced into the main gas flow path 13.

Specifically, the gas flow pressure and the temperature of the injection gas flow flowing into the main gas flow path 13 are controlled, so that the temperature of the leakage gas flow of the dry gas sealing device and the temperature of the gas flow at the outlet of the isolation gas flow branch 6 are adapted to the oil temperature at the inlet of the bearing in the gearbox 1. As a result, the pressure difference between the leakage gas flow formed after the injection gas flow enters the dry gas sealing device through the main gas flow branch 8 and the injection gas flow after entering the gearbox 1 through the isolation gas flow branch 6 is reduced, thereby effectively lowering the impact on the oil temperature at the inlet of the bearing in the gearbox 1 caused by the introduction of the injection gas flow. Here, the adaptation of the temperature of the leakage gas flow of the dry gas sealing device and the gas flow at the outlet of the isolation gas flow branch 6 to the oil temperature at the inlet of the bearing in the gearbox 1 refers to the temperature of the leakage gas flow of the dry gas sealing device and the gas flow at the outlet of the isolation gas flow branch 6 being close to the oil temperature at the inlet of the bearing in the gearbox 1.

The supercritical carbon dioxide zero leakage dry gas sealing device provided in the above embodiment includes a sealing cylinder 3, a moving ring 4 and a stationary ring 5 which are arranged in the sealing cylinder 3. The dry gas sealing device further includes a main gas flow path 13, a main gas flow branch 8, an isolation gas flow branch 6, a pressure reducing valve 10 and a temperature control assembly. During operation, the injection gas flow is introduced into the total gas flow path 13, and is then divided into two branches. One branch flows into the sealing cylinder 3 through the main gas flow branch 8, and the other branch flows into the gearbox 1 through the isolation gas flow branch 6. The pressure of the gas flow in the isolation gas flow branch 6 is reduced by the pressure reducing valve 10. During operation of the dry gas sealing device, the temperature of the injection gas flow introduced into the main gas flow path 13 is regulated by the temperature control assembly, such that the temperature of the leakage gas flow from the dry gas sealing device, the temperature of the gas flow at the outlet of the isolation gas flow branch 6 are adapted to the oil temperature at the inlet of the bearing in the gearbox 1. That is, the temperature of the leakage gas flow from the dry gas sealing device and the temperature of the gas flow at the outlet of the isolation gas flow branch do not excessively affect the oil temperature at the inlet of the bearing in the gearbox 1. This effectively reduces the impact of the injection gas flow on the oil temperature at the inlet of the bearing in the gearbox 1, thereby ensuring the safe operation of the supercritical carbon dioxide compressor or turbine.

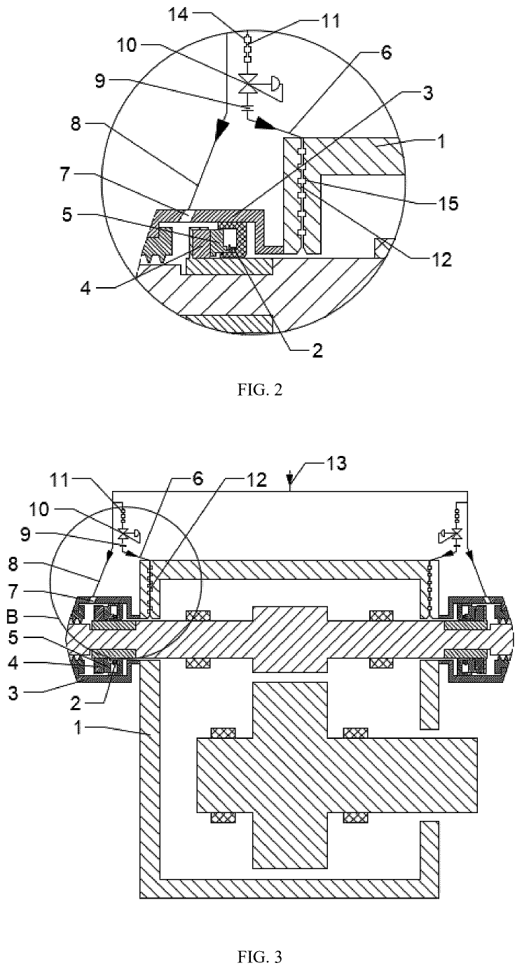

In an implementation, referring to FIG. 1 and FIG. 2, the sealing cylinder 3 is provided with an injection hole 7, the injection hole 7 is located on a side of the movable ring 4 facing away from the gearbox 1, and the injection hole 7 is in communication with the main gas flow branch 8. After flowing through the main gas flow branch 8, the injection gas flow flows into the sealing cylinder 3 through the injection hole 7, so that a rigid gas film is formed between the movable ring 4 and the stationary ring 5.

The principle of pressure drop distribution in the isolation gas flow branch 6 is that the lowest isentropic expansion temperature at the throat of the pressure reducing valve 10 should be higher than 0° C. When the temperature at the throat of the pressure reducing valve 10 falls below 0° C., moisture in the external gas working fluid may freeze on the surface of the valve stem of the pressure reducing valve 10, potentially causing valve sticking and difficulties in automatic control. Therefore, to prevent the minimum isentropic expansion temperature at the throat of the pressure reducing valve 10 from falling to or below 0° C., the pressure difference across the pressure reducing valve 10 must be limited. In an embodiment, the dry gas sealing device further includes a pressure reducing structure configured to share the pressure drop load borne by the pressure reducing valve 10.

In this embodiment, the pressure reduction structure is configured to share the pressure drop load borne by the pressure reducing valve 10. That is, providing the pressure reducing structure on the isolation gas flow branch 6 ca facilitate stepwise pressure reduction within the isolation gas flow branch 6, thereby preventing frost formation at the throat of the pressure reducing valve 10 and effectively sharing the large pressure drop load that would otherwise be borne by the pressure reducing valve 10, thus supporting the design and safe operation of the supercritical carbon dioxide compressor or turbine.

In some embodiments, the pressure difference across the pressure reducing valve 10 does not exceed 9 to 11 MPa and the remaining pressure drop load is borne by the pressure reducing structure.

In an implementation, referring to FIG. 1 and FIG. 2, the pressure reducing structure includes a resistance member 11 and a throttling hole 9, the resistance member 11 is disposed on a side of the pressure reducing valve 10 adjacent to the main gas flow path 13, and the throttling hole 9 is disposed on a side of the pressure reducing valve 10 away from the main gas flow path 13.

In this embodiment, the resistance member 11 is disposed on the side of the pressure reducing valve 10 adjacent to the main gas flow path 13, the throttling hole 9 is disposed on the side of the pressure reducing valve 10 away from the main gas flow path 13. That is, the pressure reducing valve 10 is located between the resistance member 11 and the throttling hole 9. After flowing into the isolation gas flow branch 6 from the main gas flow path 13, the injection gas flow sequentially flows through the resistance member 11, the pressure reducing valve 10, and the throttling hole 9, thereby achieving stepwise pressure reduction.

In an implementation, referring to FIG. 1 and FIG. 2, a pressure regulating groove 12 is defined on a side of the gearbox 1 close to the sealing cylinder 3, and the pressure regulating groove 12 is in communication with the isolation gas flow branch 6.

In this embodiment, the isolation gas flow branch 6 is in communication with the gearbox 1 through the pressure regulating groove 12, so that the injection gas flow can flow into the gearbox 1 through the pressure regulating groove 12, thereby isolating oil from gas.

In order to effectively share the large pressure drop borne by the pressure reducing valve 10, the resistance element 11 disposed upstream of the pressure reducing valve 10 needs to bear a relatively large portion of the pressure drop. Referring to FIG. 1 and FIG. 2, the resistance element 11 has a plurality of first protruding portions 14 connected in series. Because the upstream temperature and the pressure of the resistance element 11 are relatively high, the resistance element 11 adopts a gradually alternating structure composed of multiple stages of equal-diameter protruding portions connected in series. This enables the resistance member 11 to withstand approximately one-third to two-thirds of the pressure drop that would otherwise be borne by the pressure reducing valve 10.

Specifically, the resistance member 11 may include a plurality of first protruding portions 14 and a connecting tube. The diameter of the first protruding portion 14 is greater than a diameter of the connecting tube. The diameter of the connecting tube is greater than or equal to the diameter of the isolation gas flow branch 6. The first protruding portion 14 and the connecting tube overlap to form a structure having a plurality of protruding portions.

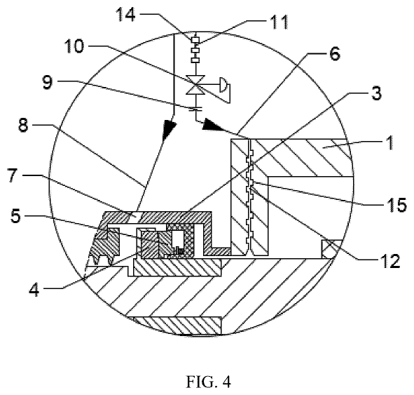

In addition, in order to further increase the pressure difference across the pressure regulating groove 12, referring to FIG. 1 to FIG. 4, the pressure regulating groove 12 has a plurality of second protruding portions 15. The plurality of second protruding portions 15 are connected in series, and the second protruding portions 15 are arranged in a symmetrical or staggered manner.

In this embodiment, the second protruding portions 15 are arranged in the symmetrical form, that is, the second protruding portions 15 ate symmetrical about a central vertical plane. This configuration facilitates the injection gas flow while also effectively increasing the pressure difference across the pressure regulating groove 12. When the second protruding portions 15 are arranged in a staggered manner, that is, under the dimensional constraints of the gearbox 1 where the overall flow length of the pressure regulating groove 12 is limited, the staggered arrangement of the second protruding portions 15 allows for an increased number of protruding portions within the limited flow length. This further increases the pressure difference across the pressure regulating groove 12, thereby meeting a higher pressure drop load and making the structure applicable to a broader range of use scenarios.

Specifically, the pressure regulating groove 12 may include a plurality of second protruding portions 15 and a connecting groove body. A diameter of the second protruding portion 15 is greater than a diameter of the connecting groove body, and the second protruding portions 15 and the connecting groove body overlap to form a structure having a plurality of protruding portions.

An embodiment of the present application further provides a supercritical carbon dioxide zero leakage dry gas sealing method, in which the temperature of the injection gas flow is controlled by the supercritical carbon dioxide zero leakage dry gas sealing device as described above.

Specifically, the supercritical carbon dioxide zero leakage dry gas sealing method includes: before introducing the injection gas flow into the main gas flow path 13, regulating the temperature of the gas injection gas flow by the temperature control assembly based on the gas flow pressure of the injection gas flow within a preset range, and introducing the injection gas flow into the sealing cylinder body 3 and the gearbox 1 through the main gas flow path 13, so that a temperature of a leakage gas flow from the dry gas sealing device and a temperature of a gas flow at an outlet of the isolation gas flow branch 6 are adapted to an oil temperature at an inlet of a bearing in the gearbox 1.

The specific operation is as follows. When the temperature of the injection gas flow has been adjusted to fall within the preset range, the injection gas flow is introduced from one end of the main gas flow path 13. After flowing through the main gas flow path 13, the injection gas flow is divided into two branches. One branch flows into the sealing cylinder 3 through the main gas flow branch 8, and the other branch flows through the isolation gas flow branch 6, during which the pressure reducing valve 10 performs pressure reduction on the gas flow. After the pressure is reduced, the injection gas flow flows into the gearbox 1. By controlling the temperature of the injection gas flow by the temperature control component, the temperature variation of the gas flow entering the sealing cylinder 3 and the gearbox 1 is regulated. As a result, the injection gas flow does not excessively affect the oil temperature at the inlet of the bearing in the gearbox 1, thereby effectively reducing the influence of the injection gas on the oil temperature at the inlet of the bearing and ensuring the safe operation of the supercritical carbon dioxide compressor or turbine.

In an implementation, the gas flow pressure of the injection gas flow introduced in the main gas flow path 13 ranges from 6 MPa to 20 MPa, which enables better adaptation to the dry gas sealing device and effectively isolates oil and gas within the downstream gearbox 1.

In an implementation, the relationship between the gas flow pressure and the temperature of the injection gas flow introduced in the main gas flow path 13 is expressed as:

$${T}_{min} = - 0.0032 {P}^{3} + 0.0041 {P}^{2} + 6.0759 P + 42.262 ; and$$

$${T}_{max} = 0.0118 {P}^{3} - 0.5304 {P}^{2} + 11.581 P + 48.1 \; 13 ;$$

Tₘᵢₙ denotes the lowest temperature of the injection gas flow, Tₘₐₓ denotes the highest temperature of the injection gas flow, and P denotes the gas flow pressure of the injection gas flow.

In this embodiment, in order to minimize the temperature variation of the leakage gas flow of the dry gas sealing device and the temperature of the gas flow at the outlet of the isolation gas flow branch 6, the deviation in the oil temperature at the inlet of the bearing in the gearbox 1 is controlled within a range of ±0.4° C. The temperature of the leakage gas flow of the dry gas sealing device and the temperature of the gas flow at the outlet of the isolation gas flow branch 6 may rise up to 62° C., and may drop to 20° C.

Specifically, when the gas flow pressure of the injection gas flow introduced in the main gas flow path 13 is 20 MPa, the highest temperature of the injection gas flow does not exceed 162° C., and the lowest temperature of the injection gas flow is not lower than 139° C.

In an implementation, during the operation of the dry gas sealing device, the downstream gas flow pressure between the moving ring 4 and the stationary ring 5 is maintained within a range of 0.11 MPa(a) to 0.15 MPa(a).

In this embodiment, controlling flow speed at the outlet of the isolation gas flow branch 6 to be less than 5 m/s can effectively prevent backflow of oil and gas. Considering that the injection gas flow is sourced from the main gas system of the compressor or turbine, in order to reduce power loss caused by the injection gas flow, the amount of injection gas flow used should be minimized. Under fixed geometric dimensions, the density of the injection gas flow can be controlled by lowering its pressure, thereby effectively increasing the flow speed and improving usage efficiency. In addition, excessively high oil pressure at the bearing in the gearbox 1 may increase the power consumption of the oil path system, raise bearing wear losses, and potentially cause the lubricant to splash from the bearing. Therefore, it is necessary to control the downstream gas pressure between the moving ring 4 and the stationary ring 5 within the range of 0.11 MPa(a) to 0.15 MPa(a).

In an implementation, the total mass of the leakage gas flow and the isolation gas flow is not higher than 5% of the mass of oil at the bearing in the gearbox 1.

In this embodiment, if the oil temperature at the inlet of the bearing is too high, the viscosity of the lubricating oil may become excessively high, leading to increased unit losses and excessive bearing temperature rise, which may in turn trigger an alarm shutdown. If the oil temperature at the inlet of the bearing is too low, the lubricating oil may oxidize and deteriorate, potentially causing incidents such as bearing failure. Therefore, the oil temperature at the inlet of the bearing is controlled within a range of 36° C. to 46° C. Because the leakage gas flow and the isolation gas flow of the dry gas sealing device in the zero leakage scenario directly flow through the bearing, if the total mass of the leakage gas flow and the isolation gas flow is too high, the oil temperature at the inlet of the bearing is more easily affected by the temperature fluctuation. Therefore, in order to reduce the sensitivity of the gas flow temperature to the temperature of the bearing oil, the total mass of the leakage gas flow and the isolation gas flow downstream of the moving ring 4 and the stationary ring 5 is not higher than 5% of the mass of the oil at the inlet of the bearing in the gearbox 1. In this case, even when the temperature of the leakage gas flow of the dry gas sealing device and the temperature of the gas flow at the outlet of the isolation gas flow branch 6 deviates by 4° C. from the preset operating range of the oil temperature at the inlet of the bearing, it will only result in a 0.1° C. deviation in the oil temperature at the inlet of the bearing, thereby significantly improving operational safety and ease of use.

The above embodiments are only some embodiments of the present application, and are not therefore intended to limit the scope of the present application. Any equivalent structure or equivalent process transformation made based on the description and drawings of the present application, directly or indirectly used in other related technical fields, are all included in the protection scope of the present application.

What is claimed is:

1. A supercritical carbon dioxide zero leakage dry gas sealing device, comprising:
a sealing cylinder;
a moving ring and a stationary ring arranged inside the sealing cylinder;
a main gas flow path configured to introduce an injection gas flow into the sealing cylinder and a gearbox;
a main gas flow branch, one end of the main gas flow branch being in communication with the main gas flow path, and the other end of the main gas flow branch being in communication with the sealing cylinder;
an isolation gas flow branch, one end of the isolation gas flow branch being in communication with the main gas flow path, the other end of the isolation gas flow branch being in communication with the gearbox, and the isolation gas flow branch being arranged in parallel to the main gas flow branch;
a pressure reducing valve disposed on the isolation gas flow branch; and
a temperature control assembly, configured to control a temperature of the injection gas flow based on a gas flow pressure of the injection gas flow introduced into the total gas flow path, so that a temperature of a leakage gas flow from the dry gas sealing device and a temperature of a gas flow at an outlet of the isolation gas flow branch are adapted to an oil temperature at an inlet of a bearing in the gearbox.

2. The supercritical carbon dioxide zero leakage dry gas sealing device according to claim 1, wherein an injection hole is provided on the sealing cylinder, the injection hole is located on a side of the movable ring facing away from the gearbox, and the injection hole is in communication with the main gas flow branch.

3. The supercritical carbon dioxide zero leakage dry gas sealing device according to claim 1, further comprising:
a pressure reducing structure for sharing a pressure drop load borne by the pressure reducing valve.

4. The supercritical carbon dioxide zero leakage dry gas sealing device according to claim 3, wherein the pressure reducing structure comprises a resistance member and a throttling hole, the resistance member is disposed on a side of the pressure reducing valve adjacent to the main gas flow path, and the throttling hole is disposed on a side of the pressure reducing valve away from the main gas flow path.

5. The supercritical carbon dioxide zero leakage dry gas sealing device according to claim 4, wherein a pressure regulating groove is defined on a side of the gearbox adjacent to the sealing cylinder, and the pressure regulating groove is in communication with the isolation gas flow branch.

6. The supercritical carbon dioxide zero leakage dry gas sealing device according to claim 5, wherein the resistance member has a plurality of first protrusion portions, and the plurality of first protrusion portions are connected in series.

7. The supercritical carbon dioxide zero leakage dry gas sealing device according to claim 6, wherein the pressure regulating groove is provided with a plurality of second protruding portions, the plurality of second protruding portions are connected in series, and the plurality of second protruding portions are arranged in a symmetrical or a staggered form.

8. A supercritical carbon dioxide zero leakage dry gas sealing method, comprising:
controlling a temperature of an injection gas flow by the supercritical carbon dioxide zero leakage dry gas sealing device according to claim 1.

9. The supercritical carbon dioxide zero leakage dry gas sealing method according to claim 8, wherein a gas flow pressure of the injection gas flow introduced in the main gas flow path ranges from 6 MPa to 20 MPa.

10. The supercritical carbon dioxide zero leakage dry gas sealing method according to claim 9, wherein a relationship between the gas flow pressure and a temperature of the injection gas flow introduced in the main gas flow path is expressed as:
$${T}_{min} = - 0.0032 {P}^{3} + 0.0041 {P}^{2} + 6.0759 P + 42.262 ; and$$
$${T}_{max} = 0.0118 {P}^{3} - 0.5304 {P}^{2} + 11.581 P + 48.1 \; 13 ;$$
wherein Tₘᵢₙ denotes a lowest temperature of the injection gas flow; Tₘₐₓ denotes a highest temperature of the injection gas flow; and P denotes the gas flow pressure of the injection gas flow.
